(19) United States
(12) Patent Application Publication
(10) Pub. No.: US 2024/0280410 A1
(43) Pub. Date: Aug. 22, 2024

(54) TEMPERATURE MEASUREMENT DEVICE, TEMPERATURE MEASUREMENT METHOD, AND ELECTRIC APPARATUS

(71) Applicant: Mitsubishi Electric Corporation, Tokyo (JP)

(72) Inventors: Yuka TSUDA, Tokyo (JP); Takahiro NAKAI, Tokyo (JP); Yudai NAKAMURA, Tokyo (JP); Masaaki SHIMADA, Tokyo (JP)

(73) Assignee: Mitsubishi Electric Corporation, Tokyo (JP)

(21) Appl. No.: 18/570,085

(22) PCT Filed: Jun. 23, 2021
(86) PCT No.: PCT/JP2021/023694

§ 371 Date: Dec. 14, 2023

(51) Int. Cl. G01J 5/08; G01J 5/00

(52) U.S. Cl. CPC G01J 5/0859; G01J 2005/0077

(57) ABSTRACT

A thermal image sensor to acquire a relative temperature and a temperature sensor to acquire an absolute temperature are provided in a space; a reference point is set at a position different from a temperature sensor installation position; and an absolute temperature of the reference point is estimated from a measurement value of the temperature sensor, a vertical component of a distance from the temperature sensor installation position to the reference point, a vertical component of a distance from the upper surface to the lower surface of the space, and a temperature coefficient of the space. A correction value is determined from the absolute temperature and relative temperature of the reference point, and an absolute temperature distribution is generated from the relative temperature distribution and the correction value. This allows a non-contact measurement of the absolute temperature of a measurement target with a simple configuration and without installation location restriction.

### TECHNICAL FIELD

The present disclosure relates to a temperature measurement device, a temperature measurement method, and an electric apparatus, to which a thermal image sensor is applied.

### BACKGROUND ART

In recent years, non-contact temperature measurement techniques and products have been proposed using infrared cameras to detect infrared radiation emitted from the surfaces of objects. However, infrared cameras measure relative temperatures, and it is difficult to measure absolute temperatures.

Then, a technique of correcting a relative temperature measured by an infrared camera to an absolute temperature has been studied. For example, in Patent Document 1, a blackbody furnace capable of absolute temperature measurement is installed in a device for monitoring containment vessels, and by measuring the temperature of the blackbody furnace, the relative temperature of a measurement target acquired by an infrared camera is corrected to an absolute temperature, enabling non-contact, absolute temperature measurement of the measurement target. In Patent Document 2, a mirror-finished shutter is installed on the side facing the temperature-controlled infrared detector, and the infrared radiation emitted by the infrared detector itself is reflected by the shutter to serve as a reference heat source, which is used to correct the relative temperature of a measurement target to its absolute temperature; this allows non-contact measurement of the absolute temperature of the measurement target.

### PRIOR ART DOCUMENT

### Patent Document

### [Patent Document 1]

Japanese Unexamined Patent Publication No. H9-79910

### [Patent Document 2]

Japanese Unexamined Patent Publication No. 2000-131149

### SUMMARY OF INVENTION

### Problems to be Solved by Invention

However, when a heavy object such as a blackbody furnace is installed inside the device, there are restrictions on the installation location. In addition, when a mirror-finished shutter, a shutter driver, etc. are installed in the device, the device becomes more complex.

The present disclosure is made to solve the aforementioned problems and an object thereof is to provide a temperature measurement device without restriction of the installation location and can be realized with a simple configuration. Another object of the present invention is to provide an electric apparatus to which the temperature measurement device is applied.

### Means for Solving Problems

A temperature measurement device according to the present disclosure is to measure temperature in a space having an upper surface and a lower surface, and the temperature measurement device includes: a thermal image sensor to acquire a relative temperature and a temperature sensor to acquire an absolute temperature in the space; a reference point temperature estimation unit to estimate, when a reference point is set at a position different from a position where the temperature sensor is installed, an absolute temperature of the reference point from a measurement value of the temperature sensor, a vertical component of a distance from an installation position of the temperature sensor to the reference point, a vertical component of a distance from the upper surface to the lower surface, and a temperature coefficient of the space; and an absolute temperature distribution generation unit to determine a correction value from the absolute temperature of the reference point estimated by the reference point temperature estimation unit and the relative temperature of the reference point acquired by the thermal image sensor, and generate an absolute temperature distribution from the relative temperature distribution acquired by the thermal image sensor and the correction value.

A temperature measurement method according to the present disclosure includes: a reference point setting step of setting a reference point at a position different from a position where a temperature sensor for acquiring an absolute temperature is installed; a reference point temperature estimation step of estimating an absolute temperature of the reference point from a measurement value of the temperature sensor, a vertical component of a distance from an installation position of the temperature sensor to the reference point, a vertical component of a distance from the upper surface to the lower surface, and a temperature coefficient of the space; and absolute temperature distribution generation step of determining a correction value from the absolute temperature of the reference point estimated in the reference point temperature estimation step and a relative temperature of the reference point acquired by a thermal image sensor, and generating an absolute temperature distribution from a relative temperature distribution acquired by the thermal image sensor and the correction value.

An electric apparatus according to the present disclosure controls functions on the basis of the temperature measurement device according to the present disclosure and an absolute temperature selected from an absolute temperature distribution generated by the absolute temperature distribution generation unit of the temperature measurement device.

### Effects of Invention

According to the present disclosure, the absolute temperature of a measurement target can be measured in a non-contact manner with a simple configuration without being restricted by the installation location.

### BRIEF DESCRIPTION OF DRAWINGS

FIG. 1 is a block diagram showing a schematic configuration of a temperature measurement device according to Embodiment 1.

FIG. 2 is a perspective view of a space where the temperature measurement device according to Embodiment 1 is installed.

FIG. 3 is a cross-sectional view showing a part of the space where the temperature measurement device according to Embodiment 1 is installed.

FIG. 4 is an image diagram of a thermal image acquired by a thermal image sensor according to Embodiment 1.

FIG. 5 is a flowchart showing a temperature measurement method according to Embodiment 1.

FIG. 6 is a block diagram of a temperature measurement device according to Embodiment 2.

FIG. 7 is a flowchart showing a temperature measurement method according to Embodiment 2.

FIG. 8 is a block diagram of a temperature measurement device according to Embodiment 3.

FIG. 9 is a flowchart showing a temperature measurement method according to Embodiment 3.

FIG. 10 is a block diagram of an electric apparatus according to Embodiment 3.

### EMBODIMENTS FOR CARRYING OUT INVENTION

### Embodiment 1

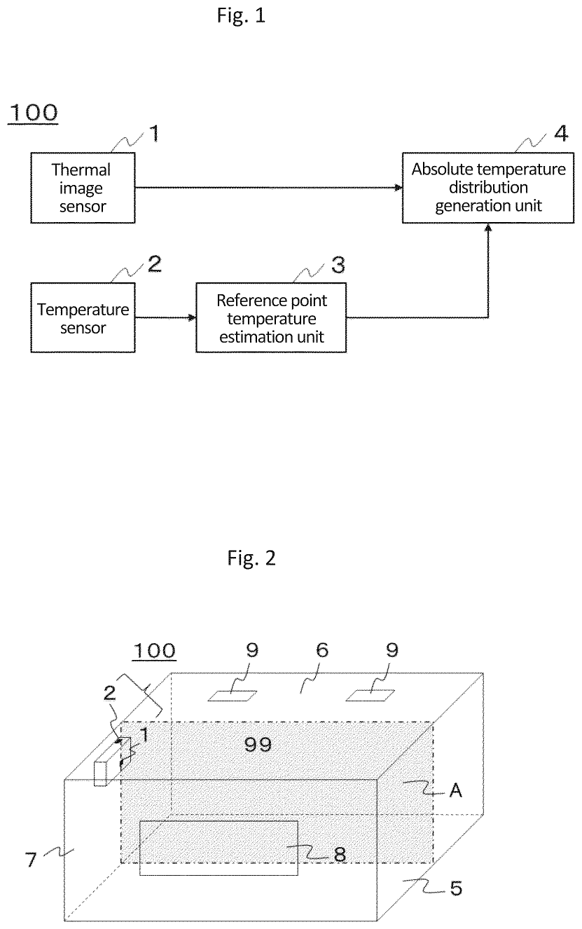

A temperature measurement device according to Embodiment 1 will be described with reference to FIG. 1 to FIG. 5.

As shown in FIG. 1, the temperature measurement device 100 includes a thermal image sensor 1 such as an infrared camera to acquire a relative temperature, a temperature sensor 2 such as a thermocouple to acquire an absolute temperature, and a reference point temperature estimation unit 3 and an absolute temperature distribution generation unit 4 which are configured with, for example, a microprocessor, a micro processing unit, or the like.

For example, as shown in FIG. 2, the temperature measurement device 100 is installed in a space 99 having a ceiling as an upper surface 6 and a floor as a lower surface 5. The space 99 is closed by the upper surface 6, the lower surface 5, and side surfaces 7 such as walls; in this example, the space 99 is provided with an opening 8, such as a window on a side surface 7, and a light emitting objects 9, such as lights that serve as heat sources.

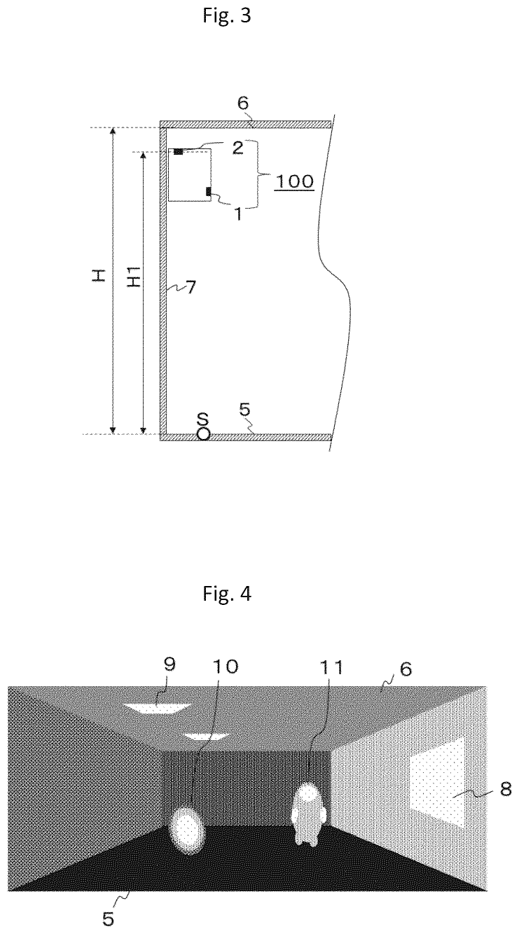

As shown in FIG. 3, which shows a part of the cross section A in FIG. 2, a reference point S is set at a position different from the installation position of the temperature sensor 2, for example, on the lower surface 5; the vertical component of the distance from the reference point S to the temperature sensor 2 and the vertical component of the distance from the upper surface 6 to the lower surface 5 are inputted to the temperature measurement device 100 as installation information, for example, at the time of installation. The vertical component of the distance from the reference point S to the temperature sensor 2 is a height H1 from the lower surface 5 to the temperature sensor 2, and the vertical component of the distance from the upper surface 6 to the lower surface 5 is a height H from the lower surface 5 to the upper surface 6.

The relative temperature distribution acquired by the thermal image sensor 1 will be described with reference to FIG. 4. The thermal image sensor 1 captures radiation heat emitted from the surface of an object. The thermal image sensor 1 displays the captured amount of radiation heat as a grayscale image; for example, as in FIG. 4, it shows, as images, measurement targets such as the lower surface 5, the upper surface 6, the opening 8, the light emitting objects 9, a stationary heat source 10, and a moving heat source 11. Here, for example, the lower surface 5 is the floor, the upper surface 6 is the ceiling, the opening 8 is the window, the light emitting objects 9 are the lights, the stationary heat source 10 is a heating appliance, a cooking appliance, etc., and the moving heat source 11 is a living thing such as a person or a pet. Because the floor and the walls heated by sunlight coming in through the window also have higher surface temperatures, the thermal image sensor 1 captures them as having higher relative temperatures as well as the heat sources. In the example of FIG. 4, a darker color indicates a smaller amount of radiation heat, that is, a lower surface temperature, and a whiter color indicates a larger amount of radiation heat, that is, a higher surface temperature. The thermal image sensor 1 captures images within the space 99 so as to overlook the space 99.

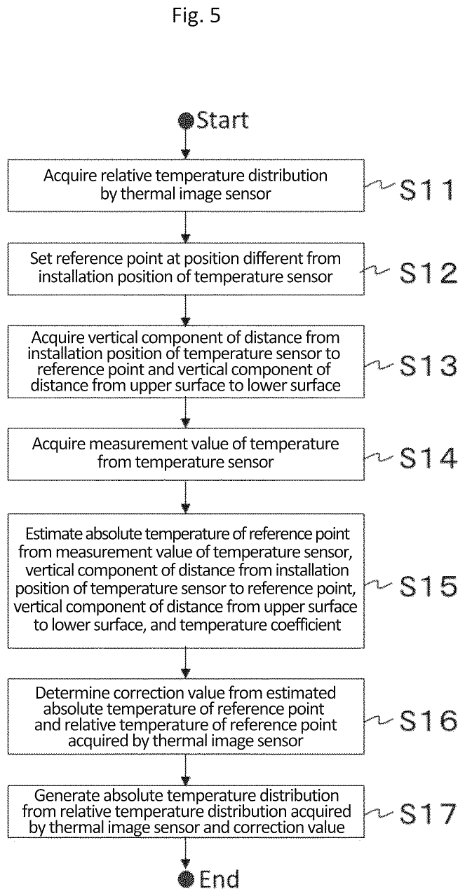

A temperature measurement method in the temperature measurement device 100 will be described with reference to FIG. 5. In step S11, the thermal image sensor 1 estimates the absolute temperature of the reference point S. In step S12, a reference point S is set at a position different from the installation position of the temperature sensor 2 (reference point setting step). In step S13, the vertical component of the distance from the installation position of the temperature sensor 2 to the reference point S and the vertical component of the distance from the upper surface 6 to the lower surface 5 are acquired. In step S14, a measurement value of the temperature is acquired from the temperature sensor 2. In step S15, the absolute temperature of the reference point S is estimated from the measurement value of the temperature sensor 2, the vertical component of the distance from the installation position of the temperature sensor 2 to the reference point S, the vertical component of the distance from the upper surface 6 to the lower surface 5, and a temperature coefficient (reference point temperature estimation step). In step S16, a correction value is determined from the estimated absolute temperature of the reference point S and the relative temperature of the reference point S acquired by the thermal image sensor 1. In step S17, a relative temperature distribution is obtained from the relative temperature distribution acquired by the thermal image sensor 1 and the correction value (absolute temperature distribution generation step).

That is, the temperature measurement is performed by: the reference point setting step of setting a reference point S at a position different from a position where the temperature sensor 2 for acquiring an absolute temperature is installed; the reference point temperature estimation step of estimating the absolute temperature of the reference point S from the measurement value of the temperature sensor 2, the vertical component of the distance from the installation position of the temperature sensor 2 to the reference point S, the vertical component of the distance from the upper surface 6 to the lower surface 5, and the temperature coefficient of the space 99; and the absolute temperature distribution generation step of determining a correction value from the absolute temperature of the reference point S estimated in the reference point temperature estimation step and the relative temperature of the reference point S acquired by the thermal image sensor 1, and generating an absolute temperature distribution from the relative temperature distribution acquired by the thermal image sensor 1 and the correction value.

Here, the vertical component of the distance from the upper surface 6 to the lower surface 5 is a positive numerical value H regardless of whether the reference point S is positioned on the floor or the ceiling. The vertical component of the distance from the installation position of the temperature sensor 2 to the reference point S is a positive numerical value when the reference point S is below the temperature sensor 2 and a negative numerical value when the reference point S is above the temperature sensor 2.

For the temperature coefficient at the S15 of the step, for example, a thermal insulation coefficient D, which is the temperature difference between the ceiling surface and the floor surface when the ZEH (Net Zero Energy House by the Ministry of Economy and Industry and the Ministry of Environment) standard is satisfied, can be used. When the ZEH standard is satisfied, the thermal insulation property is maintained by, for example, placing thermal insulation materials in the walls or under the floor so that the difference in temperature between the ceiling surface and the floor surface is 3.0 deg C. or less. When the thermal insulation coefficient D is 3.0 deg C., the temperature change per height is D/H, and thus the temperature coefficient is (the thermal insulation coefficient)/(the vertical component of the distance from the upper surface 6 to the lower surface 5). The thermal insulation coefficient D may be inputted in advance to a storage unit or the like of the temperature measurement device 100. A table of thermal insulation coefficients D may be created, and selection may be made according to the conditions of the space 99.

A method of estimating the absolute temperature of the reference point S in step S15 will be described. Usually, the temperature distribution from the floor to the ceiling is substantially uniform. Using this characteristic, the absolute temperature of the reference point S is estimated. When the measurement value of the temperature sensor 2 is Tm, the absolute temperature Ts of the reference point S is obtained by the following equation (1).

$$Ts = Tm - ( D / H ) \times H 1 \qquad ( 1 )$$

The reference point S should be at a different position from the installation position of the temperature sensor 2, and the reference point S may be located on the ceiling. When the reference point S is above the temperature sensor 2, a negative numerical value H1 is entered into the equation (1).

A method of generating the absolute temperature distribution in step S17 will be described. In the relative temperature distribution inputted from the thermal image sensor 1, the relative temperature at the reference point S is defined as the reference point temperature calculated by the reference point temperature estimation unit 3; in addition, the correction value is determined to be, for example, the temperature difference between the reference point temperature and the relative temperature at the reference point S acquired by the thermal image sensor 1. The absolute temperature of each position different from the reference point S is calculated by, for example, adding the correction value to the relative temperature acquired by the thermal image sensor 1, and the absolute temperature distribution of the entire area captured by the thermal image sensor 1 is generated as the absolute temperature of each position. A relative temperature distribution of a part of the area may be generated. In this way, if there is a measurement target in the space 99, the absolute temperature of the measurement target can be known from the generated absolute temperature distribution.

The absolute temperature may be calculated by subtracting the correction value from the relative temperature acquired by the thermal image sensor 1. When the numerical value acquired by the thermal image sensor 1 is not converted into a temperature, the correction value may be determined such that the numerical value is converted into a temperature. The correction value may not be a constant. For example, it may be a function such as a weighted formula in the space 99.

As described above, the temperature measurement device 100 according to Embodiment 1 can measure the absolute temperature of a measurement target in a non-contact manner without installing a heavy object such as a blackbody furnace or an auxiliary device such as a shutter. Thus, the absolute temperature of the measurement target can be measured in a non-contact manner with a simple configuration without being restricted by the installation location.

Although an example has been described in which the vertical component H of the distance from the upper surface 6 to the lower surface 5 and the vertical component H1 of the distance from the reference point S to the temperature sensor 2 are initially inputted, a laser displacement meter may be provided in the temperature measurement device 100 to measure the distances, for example. In addition, the reference point S may be set at an arbitrary position and automatically acquired. In this case, the temperature measurement device 100 may be provided with a distance measurement unit, a reference point setting unit, and the like, which are not shown. Although an example has been described in which the entire temperature measurement device 100 is installed inside the space 99, a part of the temperature measurement device 100 may be located outside the space 99 as long as at least the temperature sensor 2 is in the space 99.

Note that, an example has been described in which step S14, in which a temperature is measured by the temperature sensor 2, is performed before step S15, in which the absolute temperature of the reference point S is estimated; however, the order may be changed such that, for example, step S14 is performed after step S12, in which the position of the reference point S is determined. That is, the temperature measurement by the temperature sensor 2 should be performed before the reference point temperature estimation step.

### Embodiment 2

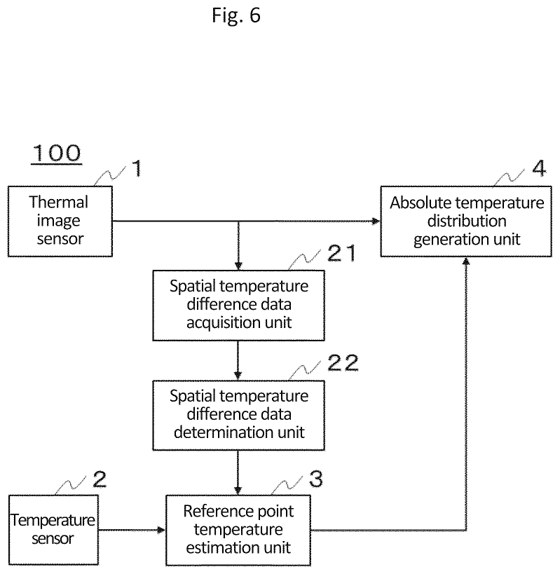

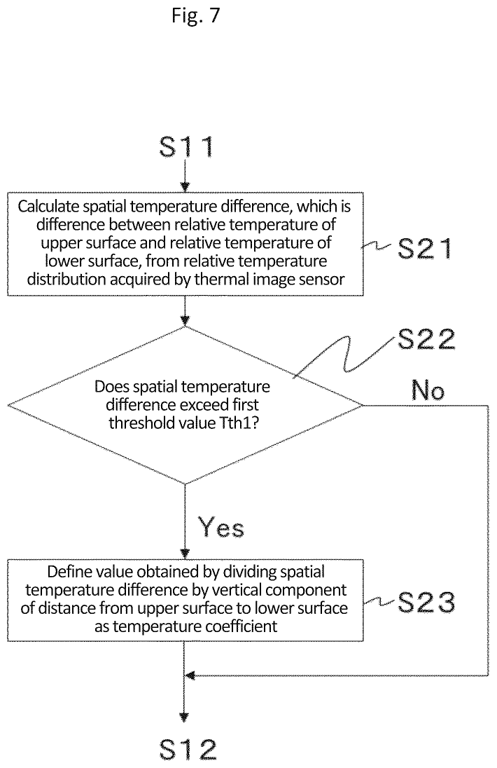

A temperature measurement device according to Embodiment 2 will be described with reference to FIG. 6 and FIG. 7.

As shown in FIG. 6, the temperature measurement device 100 includes: a thermal image sensor 1 such as an infrared camera to acquire a relative temperature; a temperature sensor 2 such as a thermocouple to acquire an absolute temperature; and a reference point temperature estimation unit 3, an absolute temperature distribution generation unit 4, a spatial temperature difference data acquisition unit 21, and a spatial temperature difference data determination unit 22, which are configured with, for example, a microprocessor, a micro processing unit, or the like. The temperature measurement device 100 according to the present embodiment has the same configuration as the temperature measurement device 100 shown in Embodiment 1 except that the spatial temperature difference data acquisition unit 21 and the spatial temperature difference data determination unit 22 are further provided.

FIG. 7 is a flowchart showing a procedure for determining the temperature coefficient, which is performed, for example, between step S11 and step S12 that are described in Embodiment 1, step S11 being the step in which the relative temperature distribution is obtained from the thermal image sensor 1, and step S12 being the step in which a reference point S is set at a position different from a position where the temperature sensor 2 for acquiring an absolute temperature is installed. A procedure for determining the temperature coefficient will be described with reference to FIG. 7.

In step S21, the relative temperature of the upper surface 6 and the relative temperature of the lower surface 5 are acquired from the relative temperature distribution acquired by the thermal image sensor 1, and the spatial temperature difference, which is the difference between the relative temperature of the upper surface 6 and the relative temperature of the lower surface 5, is calculated. Then, in step S22, it is determined whether or not the spatial temperature difference exceeds a predetermined first threshold value Tth1. For example, the first threshold value Tth1 is set to the thermal insulation coefficient D according to the ZEH standard shown in Embodiment 1, and when the spatial temperature difference is larger than the thermal insulation coefficient D, it is determined that the spatial temperature difference exceeds the first threshold value Tth1. When it is determined in step S22 that the spatial temperature difference exceeds the first threshold value Tth1 (Yes), a value obtained by dividing the spatial temperature difference by the vertical component of the distance from the upper surface 6 to the lower surface 5 is defined as the temperature coefficient. When it is determined in step S22 that the spatial temperature difference is equal to or smaller than the first threshold value Tth1 (No), the temperature coefficient is not changed or is obtained by the procedure described in Embodiment 1.

That is, in the spatial temperature difference data acquisition unit 21, the spatial temperature difference, which is the difference between the relative temperature of the upper surface 6 and the relative temperature of the lower surface 5, is acquired from the relative temperature distribution acquired by the thermal image sensor 1 (spatial temperature difference acquisition step), and in the spatial temperature difference data determination unit 22, when the spatial temperature difference exceeds the first threshold value Tth1, a value obtained by dividing the spatial temperature difference by the vertical component of the distance from the upper surface 6 to the lower surface 5 is defined as the temperature coefficient. (spatial temperature difference determination step).

As described above, the temperature measurement device 100 according to Embodiment 2 obtains the temperature change per height from the temperature difference between the upper surface 6 and the lower surface 5 of the space 99 and defines the temperature change per height as the temperature coefficient; therefore, the absolute temperature of the reference point S can be estimated more accurately, and the absolute temperature can be generated more accurately.

Note that an example has been described in which the temperature coefficient determination procedure is performed between step S11, in which the relative temperature distribution is obtained from the thermal image sensor 1, and step S12, in which the reference point S is set at a position different from a position where the temperature sensor 2 is installed; however, the order may be changed such that, for example, the temperature coefficient determination procedure may be performed after step S14, in which the temperature measurement value is obtained from the temperature sensor 2. That is, the temperature coefficient determination procedure should be performed before the reference point temperature estimation step.

### Embodiment 3

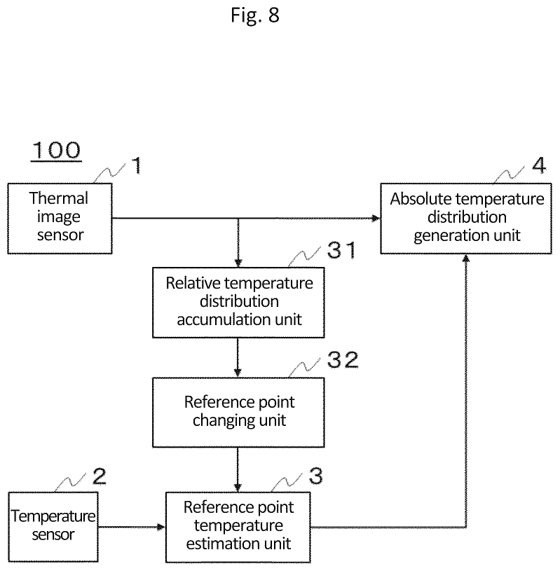

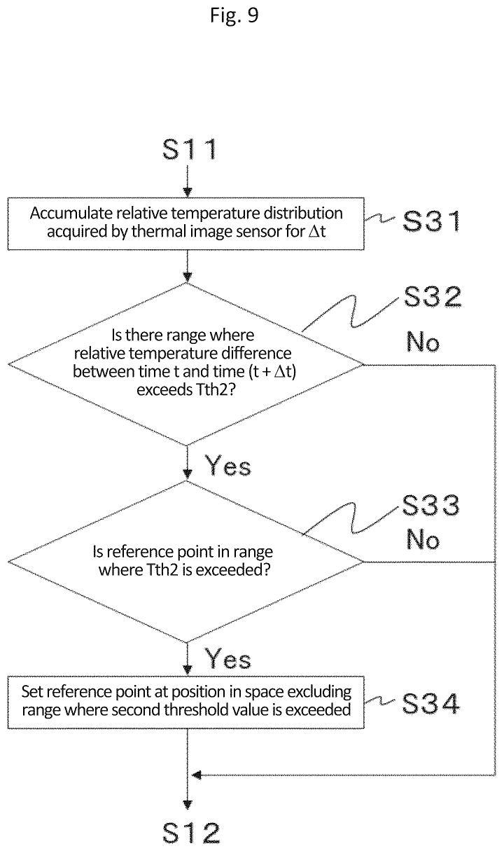

A temperature measurement device according to Embodiment 3 will be described with reference to FIG. 8 and FIG. 9.

As shown in FIG. 8, the temperature measurement device 100 includes: a thermal image sensor 1 such as an infrared camera to acquire a relative temperature; a temperature sensor 2 such as a thermocouple to acquire an absolute temperature; and a reference point temperature estimation unit 3, an absolute temperature distribution generation unit 4, a relative temperature distribution accumulation unit 31, and a reference point changing unit 32, which are configured with, for example, a microprocessor, a micro processing unit, or the like. The temperature measurement device 100 according to the present embodiment has the same configuration as the temperature measurement device 100 shown in Embodiment 1 except that the relative temperature distribution accumulation unit 31, and the reference point changing unit 32 are further provided.

FIG. 9 is a flowchart showing a procedure for determining the reference point, which is performed, for example, between step S11 and step S12 that are described in Embodiment 1, step S11 being the step in which the relative temperature distribution is obtained from the thermal image sensor 1, and step S12 being the step in which the reference point S is set at a position different from a position where the temperature sensor 2 for acquiring an absolute temperature is installed. A procedure for determining the reference point S will be described with reference to FIG. 9. In step S31, the relative temperature distribution acquired by the thermal image sensor 1 is accumulated in the relative temperature distribution accumulation unit 31 for a predetermined time interval Δt. In step S32, it is determined whether or not the relative temperature difference between the time t and the time (t+Δt) exceeds a predetermined second threshold value Tth2, and the range where the second threshold value Tth2 is exceeded is identified. For example, when the second threshold value Tth2 is set to 5 deg C. and the relative temperature difference between the time t and the time (t+Δt) is larger than 5 deg C., it is determined that the relative temperature difference exceeds the second threshold value Tth2 and, for example, its coordinates or the like in the image showing the relative temperature distribution of the thermal image sensor 1 are identified. The second threshold value Tth2 may be a negative value, and the determination may be made on the basis of the relationship between the relative temperature difference and the second threshold value Tth2. When it is determined in step S32 that the relative temperature difference between the time t and the time (t+Δt) exceeds the second threshold value Tth2 (Yes), it is determined in step S33 whether or not the reference point S is in the range where the second threshold value Tth2 is exceeded. When it is determined in step S33 that a point in the range where the second threshold value Tth2 is exceeded is set as the reference point S (Yes), in step S34, the reference point S is set at a position in the space 99 excluding the range where the second threshold value Tth2 is exceeded. For example, by determining whether coordinates in the image identified in step S32 coincide with those of the reference point S or whether the reference point S exists in the identified range, if it is found that they coincide or the reference point S exists in the identified range, the X and Y coordinates of the reference point S are shifted by Δx and Δy, and this routine is repeated to move the reference point S until coordinates outside the identified range are found. When it is determined in step S32 that the relative temperature difference between the time t and the time (t+Δt) does not exceed the second threshold value Tth2 (No), or when it is determined in step S33 that the reference point is not in the range where the second threshold value Tth2 is exceeded (No), the reference point S is not moved, and the process proceeds to step 12 described in Embodiment 1. That is, in the relative temperature distribution accumulation unit 31, the relative temperature distribution acquired by the thermal image sensor 1 is accumulated for a predetermined time interval Δt (relative temperature distribution accumulation step); in the reference point changing unit 32, when the range in which temperature difference within the time interval Δt exceeds the second threshold value Tth2 in the relative temperature distribution accumulated in the relative temperature distribution accumulation unit 31 is identified and the reference point S is in the range where the second threshold value Tth2 is exceeded, the reference point S is set at a position in the space 99 excluding the range where the second threshold value Tth2 is exceeded (reference point changing step).

As described above, because the temperature measurement device 100 according to Embodiment 3 excludes the position where the relative temperature difference is large from that of the reference point S, the absolute temperature of the reference point S can be estimated more accurately, and the absolute temperature can be generated more accurately.

In Embodiments 1 through 3, data may be inputted and outputted at any timing; the temperature measurement device 100 may be provided with a timing control unit for controlling the timing at which the thermal image sensor 1 acquires the relative temperature distribution. Although an example has been described in which the upper surface 6 and the lower surface 5 are a ceiling and a floor that have flat surfaces, the upper surface 6 and the lower surface 5 may be curved surfaces.

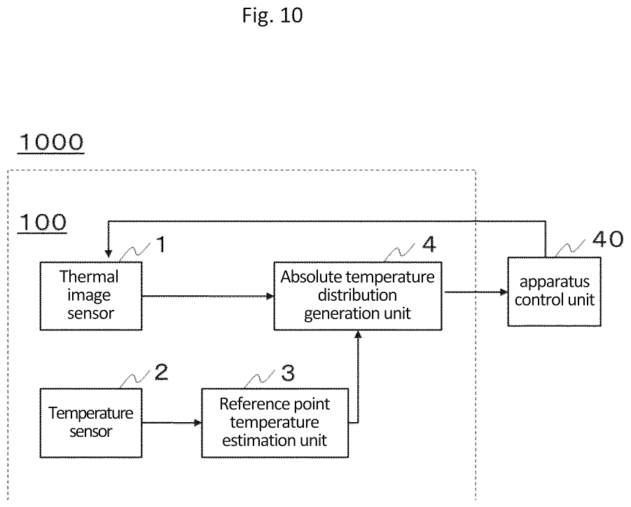

In addition, the temperature measurement device 100 of the present disclosure can measure the absolute temperature of the measurement target in a non-contact manner with a simple configuration without being restricted by the installation location; thus, for example, as shown in FIG. 10, by providing an apparatus control unit 40 for controlling an electric apparatus 1000, advanced control of various kinds of the electric apparatus 1000 can be performed. For example, the heating function of an air conditioner can be controlled by providing the temperature measurement device 100 in the air conditioner and detecting a range where the temperature is less than the set temperature of the air conditioner from the absolute temperature distribution of the space 99 in the room. The cooling function may be controlled by detecting a range where the temperature exceeds the set temperature of the air conditioner. The strength and temperature of the wind blowing onto the measurement target may be controlled on the basis of the generated absolute temperature distribution.

The temperature measurement device 100 may be provided in a driver monitoring system for monitoring a driver of a vehicle such as an automobile, a train, an airplane, or a ship. For example, the temperature measurement device 100 may be installed on the dashboard of an automobile to detect the body surface temperature of the driver from the absolute temperature distribution, and when the detected temperature exceeds or falls below a predetermined threshold value, a warning may be issued or the brake may be controlled.

As described above, the electric apparatus 1000 configured with the temperature measurement device 100 allows for advanced control of functions of the electric apparatus 1000 on the basis of the absolute temperature selected from the absolute temperature distribution generated by the absolute temperature distribution generation unit 4.

In addition to those described above, the embodiments can be freely combined, or any components in the embodiments can be modified or any components in the embodiments can be omitted.

### DESCRIPTION OF REFERENCE NUMERALS

1 thermal image sensor,
2 temperature sensor,
3 reference point temperature estimation unit,
4 absolute temperature distribution generation unit,
5 lower surface,
6 upper surface,
7 side surface,
8 opening,
9 light emitting objects,
10 stationary heat source,
11 moving heat source,
21 spatial temperature difference data acquisition unit,
22 spatial temperature difference data determination unit,
31 relative temperature distribution accumulation unit,
32 reference point changing unit,
99 space,
100 temperature measurement device,
1000 electric apparatus

1. A temperature measurement device to measure temperature in a space having an upper surface and a lower surface, the temperature measurement device comprising:
a thermal image sensor to acquire a relative temperature in the space and a temperature sensor to acquire an absolute temperature in the space; and
processing circuitry
to estimate, when a reference point is set at a position different from a position where the temperature sensor is installed in the space, an absolute temperature of the reference point from a measurement value of the temperature sensor, a vertical component of a distance from an installation position of the temperature sensor to the reference point, a vertical component of a distance from the upper surface to the lower surface, and a temperature coefficient of the space; and
to determine a correction value from the estimated absolute temperature of the reference point and the relative temperature of the reference point acquired by the thermal image sensor, and generate an absolute temperature distribution from the relative temperature distribution acquired by the thermal image sensor and the correction value.

2. The temperature measurement device according to claim 1, wherein the reference point is on the upper surface or the lower surface.

3. The temperature measurement device according to claim 1, wherein the temperature coefficient is a temperature change per height in the space.

4. The temperature measurement device according to claim 1, wherein the temperature coefficient is D/H where D is a thermal insulation coefficient and H is a height from the upper surface to the lower surface, and the absolute temperature Ts of the reference point is obtained by a following equation (1), where Tm is a measurement value of the temperature sensor and H1 is a height from the lower surface to the temperature sensor.
$$Ts = Tm - ( D / H ) \times H 1 \qquad ( 1 )$$

5. The temperature measurement device according to claim 1, wherein
the correction value is a temperature difference between the estimated absolute temperature of the reference point and the relative temperature of the reference point in the relative temperature distribution acquired from the thermal image sensor, and
the absolute temperature distribution is generated by replacing the relative temperature of the reference point in the relative temperature distribution acquired from the thermal image sensor with the estimated absolute temperature of the reference point and adding or subtracting the correction value to or from the relative temperature at a position different from the reference point.

6. The temperature measurement device according to claim 1, wherein
the processing circuitry further acquires a spatial temperature difference being a difference between a relative temperature of the upper surface and a relative temperature of the lower surface from the relative temperature distribution acquired by the thermal image sensor, and
defines a value obtained by dividing the spatial temperature difference by the vertical component of the distance from the upper surface to the lower surface as the temperature coefficient when the spatial temperature difference exceeds a first threshold value.

7. The temperature measurement device according to claim 1, wherein
the processing circuitry further accumulates the relative temperature distribution acquired by the thermal image sensor, and
when a range where a temperature difference within a time interval exceeds a second threshold value is identified in the accumulated relative temperature distribution and the reference point is in the range where the second threshold value is exceeded, sets the reference point at a position in the space different from the range where the second threshold value is exceeded.

8. A temperature measurement method for measuring temperature in a space having an upper surface and a lower surface, the temperature measurement method comprising:
setting a reference point at a position different from a position where a temperature sensor for acquiring an absolute temperature is installed;
estimating an absolute temperature of the reference point from a measurement value of the temperature sensor, a vertical component of a distance from an installation position of the temperature sensor to the reference point, a vertical component of a distance from the upper surface to the lower surface, and a temperature coefficient of the space; and
determining a correction value from the estimated absolute temperature of the reference point and the relative temperature of the reference point acquired by a thermal image sensor for acquiring a relative temperature in the space, and generating an absolute temperature distribution from a relative temperature distribution acquired by the thermal image sensor and the correction value.

9. An electric apparatus whose function is controlled on a basis of the temperature measurement device according to claim 1, and an absolute temperature selected from an absolute temperature distribution generated by the processing circuitry of the temperature measurement device.
